(19) United States
(12) Patent Application Publication
(10) Pub. No.: US 2024/0365130 A1
(43) Pub. Date: Oct. 31, 2024

(54) ESTIMATION OF CHARACTERISTIC PARAMETERS OF A RECEPTION QUALITY AT A LOCATION IN A CELLULAR RADIOCOMMUNICATION NETWORK USING MEAN-APPROXIMATION OF CORRELATION COEFFICIENTS

(71) Applicant: Orange, Issy-les-Moulineaux (FR)

(72) Inventors: Imed HADJ KACEM, CHATILLON CEDEX (FR); Sana BEN JEMAA, CHATILLON CEDEX (FR)

(21) Appl. No.: 18/648,090

(22) Filed: Apr. 26, 2024

(30) Foreign Application Priority Data
Apr. 28, 2023 (FR) 2304339

(51) Int. Cl. H04W 16/18; H04B 17/336

(52) U.S. Cl. CPC H04W 16/18; H04B 17/336

(57) ABSTRACT

A method for estimating characteristic parameters of a reception quality at a location of a cellular radiocommunication network including: selecting, from a set of network cells, at least two cells associated with the highest mean receive powers of a useful signal at the location; determining, on the logarithmic scale, at least two signal-to-interference plus noise ratios at the location for the useful signal received from each of the at least two cells selected; determining a correlation coefficient between the at least two signal-to-interference-plus-noise ratios determined on the logarithmic scale, determining a maximum between the at least two signal-to-interference-plus-noise ratios determined on the logarithmic scale; estimating characteristic parameters of a reception quality at the location from the maximum and the correlation coefficient.

### CROSS-REFERENCE TO RELATED APPLICATIONS

Any and all applications for which a foreign or domestic priority claim is identified in the Application Data Sheet as filed with the present application are hereby incorporated by reference under 37 CFR 1.57. This application claims foreign priority to French Application No. 2304339, entitled “ESTIMATION OF CHARACTERISTIC PARAMETERS OF A RECEPTION QUALITY AT A LOCATION IN A CELLULAR RADIOCOMMUNICATION NETWORK USING MEAN-APPROXIMATION OF CORRELATION COEFFICIENTS” and filed Apr. 28, 2023, the content of which is incorporated by reference in its entirety.

### BACKGROUND

### Technical Field

The field of the development is that of cellular radiocommunications, for example in cellular communication networks of the 3G, 4G, 5G or higher type. More precisely, the development relates to the estimation of characteristic parameters of a reception quality of a useful signal, at all points of such networks, for purposes such as planning or optimizing network resources, or even monitoring network performance.

### Prior Art

Cellular radiocommunication networks are conventionally structured into neighboring cells, each of which is equipped with one or more base stations, each carrying a plurality of transmitting antennas. Cells form a pavement over a geographical zone, and one objective of the radiocommunications network operator is to ensure radio coverage for its users over the entire geographical zone considered, i.e. to ensure access to the services it provides at every point in this geographical zone, avoiding as far as possible the emergence of dead spots.

In a radio environment such as 3G (or third-generation radio communications network, also known as UMTS for “Universal Mobile Telecommunications System”), 4G (or fourth-generation radio communications network, also known as LTE for “Long Term Evolution”) and 5G (or fifth-generation radio communications network), the transmitting antennas of neighboring cells emit useful signals in the same frequency band. At any given time, each user terminal is linked to one of the cells in the network, commonly referred to as a serving cell, from which it receives the useful signal it needs.

However, in addition to the useful signal sent by its serving cell, a user terminal also receives interference signals from other cells in whose coverage zone it is located. The ability of the user terminal to correctly decode the signal intended for it depends on the reception power of the useful signal and on interference, and more particularly on the ratio of these two quantities. The “SINR” metric (Signal to Noise plus interference ratio), is the ratio of useful signal power divided by the sum of the powers of interfering signals and thermal noise, received at the receiver of the user terminal. If the user terminal is able to correctly decode the useful signal intended for it for a given service, then this service is accessible with sufficient quality at the terminal location.

The coverage zone for this service can therefore be defined as the set of locations within the cell where the received SINR is above a given threshold. Operators size and parameterize their networks according to their coverage objectives, e.g. 99% of the territory should be covered for voice service, 95% for video service, and so on. Since coverage cannot be measured at every point on the network, accurate estimation of the SINR and its characteristic parameters is crucial to ensuring that the operator's coverage objectives are met.

However, the signal transmitted by a base station and received by a user terminal is subject to variations related to the nature of the radio environment. Indeed, the reception powers at two user terminals located at the same distance from the base station are different due to the different obstacles on the path between each user terminal and the base station (reflection phenomena on major obstacles, such as buildings in urban areas or forests in rural areas, for example). In this case, there is the random phenomenon of shadowing, which adds an attenuation term to the power of the radio signal received by the user terminal.

As previously indicated, in a cellular radiocommunication network, a user terminal is typically linked to the cell offering it the highest receive power, commonly referred to as its serving cell. To estimate the coverage offered at each location in the radiocommunication network, it is therefore first necessary to determine which is the serving cell at that location, then the interfering cells, and then to estimate the SINR associated therewith. However, in the absence of measurements, and due to the random variation in signal powers received at a given location (phenomenon of shadowing), the identity of the serving cell is not always deterministically known, and may vary statistically, especially at cell edges.

However, for the sake of simplicity, previous work on this subject has been based on the hypothesis that at a given network location, the serving cell is “frozen”, and corresponds, for example, to the cell from which the useful signal with the highest mean receive power for the user terminal is received.

Thus, in the paper “SINR and rate distributions for downlink cellular networks”, IEEE Transactions on Wireless Communications, vol. 19, no. 7, pp. 4604-4616, 2020, published by the inventors of the present patent application, the authors suggest evaluating the quality of service perceived by a user terminal on the basis of the statistical distribution of the SINR ratio, which is approximated in the form of a normal random variable in the logarithmic domain, whose mean and variance can be calculated. This work is based on the simplifying hypothesis that, at a given network location, a user terminal receives a useful signal from a frozen serving cell k, and M interfering signals from M neighboring cells. The SINR at this location is then defined as the ratio of the useful signal power received from this serving cell k to the sum of the power of the thermal noise and the powers of the interfering signals received from the M neighboring cells.

In the paper, “Downlink average rate and SINR distribution in cellular networks,” IEEE Transactions on Communications, vol. 64, no. 2, pp. 847-862, February 2016, X. Yan et al. take a more particular interest in cellular networks based on OFDMA (“Orthogonal Frequency Division Multiple Access”) type multiplexing, and provide an alternative approach to statistical modeling of the SINR ratio. Their work is also based on the simplifying assumption that at a given location (r, θ) of the network, a user terminal receives a useful signal from a base station BS₀ of a frozen serving cell, and L interfering signals from base stations BSᵢ of i interfering neighboring cells.

In both publications, the characteristic parameters provided to estimate the SINR distribution are valid only if the serving cell of a user terminal remains effectively unchanged. However, in an actual environment, in which the random phenomenon of shadowing adds to the mean power of the signal received by a user terminal, it is common for several nearby cells to statistically exchange the role of serving cell at a given location of the network.

Thus, the approximation on which these two papers of prior art are based is satisfactory when the difference between the mean power of the signal received from a first cell with the highest value and the mean power of the signal received from a second cell with the second highest value is quite large, typically for user terminals close to the center of the cell. However, it reaches its limits of validity for user terminals at cell edges. Yet it should be noted that the zone at cell edges is where it is important for the network operator to know the precise SINR in order to guarantee coverage.

There is therefore a need for a technique for estimating characteristic parameters of a reception quality in a location of a cellular radiocommunication network that improves on this work of prior art. Specifically, there is a need for such a technique to improve the estimation of signal quality received at any point in a cellular radiocommunication network, especially, but not exclusively, at cell edge locations.

There is still a need for such a technique to improve estimation of characteristics of the SINR ratio, especially for planning purposes, optimizing radio coverage or even monitoring performance of a cellular radiocommunication network.

### SUMMARY

The development meets this need by providing a method for estimating characteristic parameters of a reception quality at a location in a cellular radiocommunication network, comprising:
selecting, from a set of network cells, at least two cells associated with the highest mean receive powers of a useful signal at the location;
determining, on the logarithmic scale, at least two signal-to-interference plus noise ratios at the location for the useful signal received from each of said at least two cells selected;
determining a correlation coefficient between said at least two signal-to-interference-plus-noise ratios determined on the logarithmic scale,
determining a maximum between said at least two signal-to-interference-plus-noise ratios determined on the logarithmic scale;
estimating characteristic parameters of a reception quality at the location from the maximum and the correlation coefficient.

Thus, the development is based on a completely new and inventive approach to estimating reception quality at any point in a network, for purposes such as network planning, optimizing an existing cellular radiocommunication network, or even monitoring network performance. Indeed, techniques of prior art for estimating reception quality are all based on the hypothesis that, at a given network location, there is a single, frozen serving cell to which a user terminal is linked. This is the hypothesis on which the proposals in the above-mentioned articles are based “SINR and rate distributions for downlink cellular networks”, IEEE Transactions on Wireless Communications, vol. 19, no. 7, pp. 4604-4616, 2020, published by the inventors of the present patent application and “Downlink average rate and SINR distribution in cellular networks,” IEEE Transactions on Communications, vol. 64, no. 2, pp. 847-862, February 2016, to X. Yan et al.

In contrast to this prior work, the estimation technique according to one embodiment of the development considers the realistic case where the role of serving cell can be statistically played by several neighboring cells, which is particularly frequent in the case where the user terminal is located at cell edge, due to the random nature of the phenomenon of shadowing. The present solution thus aims to identify two or more cells that can potentially play the role of serving cell at a given location, it being understood that at a given time, a user terminal is only linked to a single serving cell, from which it receives the useful signal. It further provides a method for calculating the characteristic parameters of the signal-to-interference-plus-noise ratio measured for the user terminal in this realistic case, from the signal-to-interference-plus-noise ratios measured for the user terminal for each of the radio signals transmitted by the plurality of cells likely to play the role of serving cell, namely those whose reception power of the useful signal at this location is the highest.

This signal-to-interference-plus-noise ratio, which can be described as realistic in view of the working hypothesis formulated, is calculated as a maximum, on the logarithmic scale, of the signal-to-interference-plus-noise ratios of the different potential serving cells.

Advantageously, in order to be able to estimate the characteristic parameters of a reception quality at a given location, the method is based on determining a correlation coefficient between the previously determined signal-to-interference-plus-noise ratios.

Knowing the maximum of the signal-to-interference-plus-noise ratios and a correlation coefficient between these signal-to-interference-plus-noise ratios makes it possible to estimate a number of characteristic parameters of a reception quality at a given location, and especially the probability, over a geographical zone, of having a signal-to-interference-plus-noise ratio above a given threshold, to estimate, for example, the coverage quality of the cellular radiocommunication network.

In one particular embodiment, determining the correlation coefficient comprises approximating the correlation coefficient. This approximation is determined by calculating a mean of a set of correlation coefficients between said at least two signal-to-interference-plus-noise ratios determined on the logarithmic scale. Estimating the characteristic parameters of a reception quality at the location is then done using the maximum and the correlation coefficient approximated from the mean calculated.

According to the work of S C. E. Clark, “The greatest of a finite set of random variables, in Operations Research, Vol. 9, No. 2, 145-162, 1961, mean and variance can be calculated for the maximum of two correlated normal random variables, assuming the correlation coefficient between these two variables is known. In the case of cellular network planning and optimization, the correlation coefficient between the SINRs of two potentially serving cells on the logarithmic scale is not a known quantity. Thus, according to one embodiment of the development, the correlation coefficient is calculated iteratively, and then its mean is calculated.

This correlation coefficient is then approximated by its mean directly on the logarithmic scale. Thus, the network operator does not need to calculate the correlation coefficient at every point on the network. According to the development, the correlation coefficient is calculated only once for all potentially serving cells two by two. Hence, implementation of the method requires less computation power for network planning and optimization tools.

Advantageously, it is possible to reserve a limited amount of memory space to store once and for all the mean values of the correlation coefficients between the SINRs of the cells selected (potentially serving cells).

According to one particular aspect, the method according to the development further comprises calculating a mean and a variance of said at least two signal-to-interference-plus-noise ratios determined on the logarithmic scale. Determining the correlation coefficient between said at least two signal-to-interference-plus-noise ratios determined on the logarithmic scale is then performed from the means and variances calculated for said at least two signal-to-interference-plus-noise ratios determined on the logarithmic scale.

As will be seen in greater detail later in this document, the characteristic parameters of the distributions (mean and variance) of the signal-to-interference-plus-noise ratios for individual cells are calculated, for example according to the Schwartz-Yeh technique described in the paper by C.-L. Ho, “Calculating the mean and variance of power sums with two log-normal components,” IEEE Trans. Veh. Technol., vol. 44, no. 4, pp. 756-762, 1995.

According to one particular aspect of the development, the correlation coefficient is determined according to the formula:

$${τ}_{ij} = \frac{E [ {SINR}_{i}^{dB} {SINR}_{j}^{dB} ] - {q}_{i} {q}_{j}}{{s}_{i} {s}_{j}}$$

where:
SINRᵢ and SINRⱼ respectively designate said at least two signal-to-interference-plus-noise ratios determined on the logarithmic scale of said at least two cells,
qᵢ and qⱼ respectively designate said means of said at least two signal-to-interference-plus-noise ratios determined on the logarithmic scale,
sᵢ and sⱼ respectively designate said variances of said at least two signal-to-interference-plus-noise ratios determined on the logarithmic scale.

According to another particular aspect of the development, estimating the characteristic parameters comprises calculating at least some of the elements belonging to the group comprising:
a mean of said maximum calculated;
a variance of said maximum calculated;
   from the correlation coefficient determined, and then approximated by its mean and the means and variances of said at least two signal-to-interference-plus-noise ratios determined on the logarithmic scale.

Thus, the technique of the development makes it possible to calculate the mean and variance expressions on the logarithmic scale of the maximum of the SINRs. Knowing the mean and the variance, allows finer optimization of the operator's network coverage.

According to one embodiment, the mean of the maximum calculated is calculated according to the formula:

$${q}_{z} = {q}_{i} Φ ( \frac{{q}_{i} - {q}_{j}}{θ} ) + {q}_{j} Φ ( \frac{{q}_{j} - {q}_{i}}{θ} ) + θϕ ( \frac{{q}_{i} - {q}_{j}}{θ} )$$

$$θ = \sqrt{{s}_{i}^{2} + {s}_{j}^{2} - 2 {τ}_{ij} {s}_{i} sj} ,$$

ϕ(.) is the probability density function of the standard centered normal law,
Φ(.) is the distribution function of the standard normal law,
qᵢ and qⱼ respectively designate said means of said at least two signal-to-interference-plus-noise ratios determined on the logarithmic scale,
sᵢ² and sⱼ² respectively designate said variances of said two signal-to-interference-plus-noise ratios determined on the logarithmic scale, and
τᵢⱼ is said correlation coefficient between said two signal-to-interference-plus-noise ratios determined on the logarithmic scale.

According to one embodiment, the variance of the maximum calculated is calculated according to the formula:

$${s}_{z}^{2} = ( {s}_{i}^{2} + {q}_{i}^{2} ) Φ ( \frac{{q}_{i} - {q}_{j}}{θ} ) + ( {s}_{j}^{2} + {q}_{j}^{2} ) Φ ( \frac{{q}_{j} - {q}_{i}}{θ} ) + ( {q}_{i} - {q}_{j} ) θϕ ( \frac{{q}_{i} - {q}_{j}}{θ} ) - {( {q}_{z} )}^{2}$$

$$\text{where:} θ = \sqrt{{s}_{i}^{2} + {s}_{j}^{2} - 2 {τ}_{ij} {s}_{i} {s}_{j}} ,$$

ϕ(.) is the probability density function of the standard centered normal law,
Φ(.) is the distribution function of the standard normal law,
qᵢ and qⱼ respectively designate said means of said two signal-to-interference-plus-noise ratios determined on the logarithmic scale,
sᵢ² and sⱼ² respectively designate said variances of said two signal-to-interference-plus-noise ratios determined on the logarithmic scale,
τᵢⱼ is said correlation coefficient between said two signal-to-interference-plus-noise ratios determined on the logarithmic scale, and
q_{Z} is said mean of said maximum calculated.

According to one particular aspect, determining the maximum comprises a calculation between said at least two signal-to-interference-plus-noise ratios determined on the logarithmic scale, this calculation comprising, if necessary, determining, among said at least two selected cells, at least two cells having between them a mean power difference greater than or equal to a predetermined threshold (k).

Advantageously, among the selected cells that could potentially be serving cells, it is possible to disregard cells offering very low mean receive power in comparison with cells offering high mean receive power. Indeed, when the mean receive power for a signal transmitted by a cell k is much lower than the mean power offered by a cell i offering the highest mean receive power among the selected potential serving cells, the probability that the SINR of cell k is the maximum is negligible. Thus, in order to simplify the calculation of maximum SINRs, it is judicious to disregard this cell k. For this, a threshold k (greater than 0; in dB) is set, for which if a cell's mean receive power deviates by more than k from the highest mean receive power, then its SINR is not taken into consideration when calculating the maximum of the SINRs.

The development also relates to a computer program product comprising program code instructions for implementing a method for estimating characteristic parameters of a reception quality at a location of a cellular radiocommunication network as described previously, when executed by a processor.

The development is also directed to a computer-readable recording medium on which is recorded a computer program comprising program code instructions for executing the steps of the method for estimating characteristic parameters of a reception quality at a location of a cellular radiocommunication network according to the development as described above.

Such a recording medium may consist of any entity or device capable of storing the program. For example, the medium can include a storage means, such as a ROM, for example a CD-ROM or a ROM of a microelectronics circuit, or a magnetic storage means, for example a flash disk or a hard disk.

Besides, such a storage medium may be a transmissible medium such as an electrical or optical signal, which could be conveyed via an electrical or optical cable, by radio waves or by other means, so that the computer program contained therein is remotely executable. In particular, the program according to the development may be downloaded on a network, for example the Internet network.

Alternatively, the recording medium can be an integrated circuit in which the program is incorporated, the circuit being adapted to execute or to be used in executing the aforementioned method for estimating characteristic parameters of a reception quality at a location of a cellular radiocommunication network.

The development further relates to a method for planning the deployment of a cellular radiocommunication network, which implements estimating characteristic parameters of a reception quality at a location of said network, according to the method described previously, and determining network planning parameters as a function of the characteristic parameters estimated.

Such a method can, for example, be implemented in planning tools of the Merit/Acp® or Atoll® type for example.

It also relates to a method for optimizing operating parameters of a cellular radiocommunication network, which implements estimating characteristic parameters of a reception quality at a location of said network, according to the method described previously, and determining optimized operating parameters of the network as a function of the characteristic parameters estimated.

Such a method can be integrated into optimization tools such as CSON®.

The development also relates to a method for monitoring performance of a cellular radiocommunication network, which implements estimating characteristic parameters of a reception quality at a location of said network, according to the method described previously, and estimating at least one network performance criterion as a function of the characteristic parameters estimated.

The development further relates to a system for planning deployment of a cellular radiocommunication network, which comprises a processor configured to perform the steps of the method for estimating characteristic parameters of a reception quality at a location of said network, as described previously, and to determine planning parameters of the network as a function of the characteristic parameters estimated.

The development also relates to a system for optimizing operating parameters of a cellular radiocommunication network, which comprises a processor configured to perform the steps of the method for estimating characteristic parameters of a reception quality at a location of said network, as described previously, and to determine optimized operating parameters of the network as a function of the characteristic parameters estimated.

The development finally relates to a performance monitoring system for a cellular radiocommunication network, which comprises a processor configured to perform the steps of the method for estimating characteristic parameters of a reception quality at a location of said cellular radiocommunication network as previously described, and to analyze performance of the network as a function of the characteristic parameters estimated.

### BRIEF DESCRIPTION OF THE FIGURES

Other aims, characteristics and advantages of the development will be better understood upon reading the following description, which is given by way of illustrating and in no way limiting example, in connection with the accompanying figures, in which:

FIG. 1 schematically shows a cellular radiocommunication network to which the estimation method according to different embodiments of the development can be applied;

FIG. 2 schematically illustrates the existence of a common propagation zone for the correlated cells in the network of FIG. 1;

FIG. 3 describes in a flow chart the main steps of the estimation method according to one embodiment of the development;

FIG. 4 shows in a histogram the absolute value of the error in calculating the mean of the SINR perceived by the user at a location of interest, on the logarithmic scale;

FIG. 5 schematically shows the hardware structure of a cellular radiocommunication network performance monitoring system of FIG. 1, in one embodiment of the development.

### DETAILED DESCRIPTION OF CERTAIN ILLUSTRATIVE EMBODIMENTS

The general principle of the development is based on estimating characteristic parameters of the reception quality of a useful signal at any point of a cellular radiocommunication network, based on a realistic hypothesis consisting in considering that several cells are likely to play the role of serving cell, at a given location, due to the random phenomenon of shadowing.

The solution provided enables mean and variance expressions to be calculated on the logarithmic scale for “actual°” SINR, i.e. perceived by a user terminal, at any point on a cellular radiocommunication network. Knowing the SINR mean and variance, therefore, enables finer optimization of the network coverage of an operator.

For the record, and as illustrated in FIG. 1, a cellular radiocommunication network 1, or mobile network, is comprised of a network of relay antennas (or base stations) 2₁ to 2_{N} (N=4 in the example represented), each covering a delimited portion of territory 3₁ to 3_{P} (P=4 in the example represented), commonly referred to as a cell (schematically represented in hexagonal form in FIG. 1), and routing communications as radio waves to and from user terminals located in the corresponding cell.

To access the services provided by the network operator (voice or data), a user terminal therefore needs to be located within the coverage zone of a relay antenna 2ᵢ. It has a limited range, and covers only a small territory around it, called a cell. To cover the maximum territory and ensure that user terminals always have access to the services provided, operators deploy thousands of cells 3ᵢ, each equipped with antennas 2ᵢ so that their coverage zones overlap each other, in order to provide the fullest possible meshnet of the territory.

Indeed, if a user terminal is able to correctly decode the signal intended for it for a given service, then this service is accessible with sufficient quality at the location of the user terminal. The coverage zone for this service is the set of locations where the SINR determined for the user terminal is above a given threshold. The operator dimensions and parameterizes its network according to its objectives, including coverage, for example, 99% of the territory should be covered for voice service, 95% for video service and so on. Since coverage cannot be measured at every location on the network, accurate estimation of the SINR and its characteristic parameters is crucial to meeting the operator's coverage objectives.

It will be noted that cell size depends on multiple criteria, especially the type of relay antenna used, the terrain (plain, mountain, valley . . . ), the place of installation (rural zone, urban zone . . . ), population density, etc. The size of the cell 3ᵢ is also limited by the range of the user terminals, which should be able to establish an uplink with the relay antenna.

Furthermore, a relay antenna 2₁ has a limited transmission capacity, and can only handle a certain number of simultaneous service access requests. This is why, in cities, where population density is high and the number of communications large, cells tend to be numerous and small—spaced out by a few hundred or even just a few dozen meters. In the countryside, where population density is much lower, cell sizes are much larger, sometimes extending over several kilometers, but rarely exceeding ten kilometers.

Planning and optimizing the operation of a cellular radiocommunication network 1 are therefore complex and delicate issues for the network operator. They require reliable, accurate information on the reception quality that a given configuration of base stations and cells can offer at any point on the network. This information can be obtained by knowing the signal-to-interference-plus-noise ratio, or SINR, at any point on the network. Since the latter cannot be measured at every point on the network, it is important for the operator to be able to possess a statistical estimation of this parameter and its variance and mean characteristics. Estimating SINR characteristics is then used by the operator in planning tools to optimize radio coverage.

The technique of the development aims to provide a method for estimating the SINR at any location in the network, based on the hypothesis that several cells can potentially play the role of serving cell at a given point, due to the random phenomenon of shadowing.

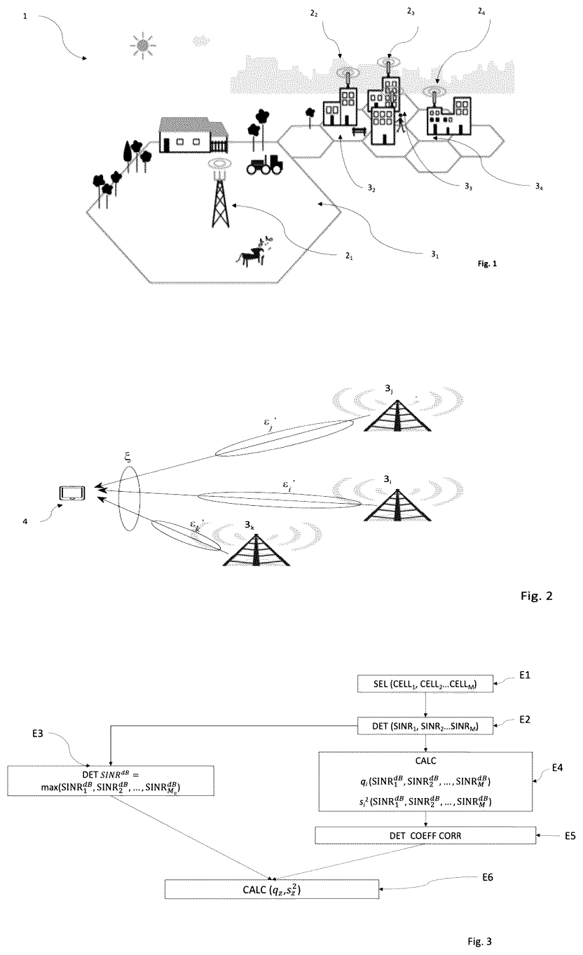

More particularly, in the following, in connection with FIGS. 2 and 3, estimating the SINR actually perceived by a user terminal 4 at a location of interest is described, in the case where it is considered that several network cells can play the role of serving cell at this location of interest.

According to a conventional approach within the scope of simulating the radio coverage of a network, it is assumed here that the values of the cell loads (ρ) are equal to each other. As a reminder, the load (ρ) of a cell corresponds to the fraction of resources allocated by the cell to user terminals located in its coverage zone.

First of all, in a step E1, a set is selected comprising at least two cells that can potentially act as a serving cell for a user terminal at a given location. In particular, the aim is to select the cells of the communication network offering the highest mean receive power for a useful signal at the location of the user terminal 4. In other words, the cells for which the user terminal 4 picks up a useful signal are selected. In one example in relation to FIG. 2, the three cells from the communication network are selected: 3ᵢ, 3ⱼ, 3ₖ.

In another example related to FIG. 3, a number M of cells (M being an integer greater than or equal to 1) is considered: cell 1, cell 2 . . . up to cell M (respectively noted: CELL₁, CELL₂ . . . CELL_{M}).

As a reminder, the expression of the SINRᵢ perceived by a user terminal at a location of interest in the case where its serving cell is cell i is:

$${SINR}_{i} = \frac{{10}^{\frac{{μ}_{i} + {ε}_{i}}{10}}}{N + {\sum }_{j = 1 , j \neq i}^{M} {ρ}_{j} {10}^{\frac{{μ}_{j} + {ε}_{j}}{10}}} \qquad ( EQ 1 )$$

where
M is the number of cells from which the user terminal at the location of interest picks up a useful signal,
N is the thermal noise power,
for 1≤i≤M, μᵢ is the mean power of the signal received from cell i. Without loss of generality, it is assumed that μ₁≥μ₂≥ . . . >μ_{M}. In other words, cell 1 (CELL₁) is considered to have a higher mean receive power than cell 2 (CELL₂), which has a higher mean receive power than cell 3 (CELL₃) and so on, with cell M (CELL_{M}) having the lowest mean receive power of all the cells selected in step E1,
εᵢ is a centered normal random variable with variance σᵢ² which designates shadowing and
ρⱼ designates the cell load j. As described previously, it is assumed here that the cell load values are equal, that is: ρ₁= . . . =ρ_{M}=ρ.

Due to the phenomenon of shadowing, the serving cell is not “frozen” and several cells can play the role of serving cell. The serving cell of the user terminal at a location of interest is therefore the one offering the highest received power, and not necessarily the one offering the highest mean receive power. In other words, if cell i is the serving cell, then: μᵢ+εᵢ>μⱼ+εⱼ (for any j≠i).

The shadowing random variables of the different cells considered are correlated, since they correspond to the impact on the power received by the user terminal of the obstacles the signal crosses during its propagation from a relay antenna to the user terminal. These obstacles present in the environment close to the user terminal are consequently the same for the different cells considered. Shadowing impacting path i, j, k (from cell 3ᵢ, 3ⱼ, 3ₖ to user terminal 4) is therefore the sum of two independent Gaussian random variables, one of which is common to all paths i, j, k to user terminal 4, as shown in FIG. 2. In this regard, one might refer to the work of S. S. Szyszkowicz, H. Yanikomeroglu, et J. S. Thompson, “On the feasibility of wireless shadowing correlation models,” IEEE Trans. Veh. Technol., vol. 59, no. 9, pp. 4222.

Thus, it can be written that

$${ε}_{i} = {{ε}^{′}}_{i} + ξ ,$$

$${ε}_{j} = {{ε}^{′}}_{j} + ξ$$

$${ε}_{k} = {{ε}^{′}}_{k} + ξ$$

Where ε′ᵢ, ε′ⱼ, ε′ₖ and ξ (1≤i≠j≠k≤M) are independent normal random variables with zero means and variances σᵢ′²=σᵢ²−β², σⱼ′²=σⱼ²−β², σₖ′²=σₖ²−β² and β², respectively, where β² is the variance of ξ.

In a step E2, in order to calculate the characteristic parameters for the so-called “actual” SINR, i.e. the SINR measured for the user terminal, in the realistic case where this “shadowing” phenomenon is taken into account, the expressions for the SINRs (SINR₁, SINR₂ . . . SINR_{M}) measured for each cell of the set of cells (CELL₁, CELL₂ . . . CELL_{M}) selected in step E1 are determined using the preceding equation EQ1. In this case, it is considered that each cell can potentially play the role of serving cell.

Consequently, if it is considered that the cells (CELL₁, CELL₂ . . . CELL_{M}) selected can statistically play the role of serving cell, the SINR measured for the user terminal at the location of interest therefore amounts to determining a maximum between all the SINRs (SINR₁, SINR₂ . . . SINR_{M}) measured, that is:

$${SINR}^{dB} = max ( {SINR}_{1}^{dB} , {SINR}_{2}^{dB} , ... , {SINR}_{M}^{dB} )$$

$$where {SINR}_{i}^{dB} = 10 {log}_{10} {SINR}_{i} , 1 \leq i \leq M ; and$$

$${SINR}^{dB} = 10 {log}_{10} SINR .$$

It is to be noted that if a cell k offers a mean receive power (μₖ) very low compared to that of the first cell (CELL₁) (in the present case, it is assumed that the first cell has the highest mean receive power among the set of cells 1 to M), in other words μₖ<<μ₁, then the probability that the SINR (SINRₖ) measured for cell k corresponds to the maximum of the SINRs is negligible. Thus, taking cell k into account adds more complexity than precision in calculating the maximum of the SINRs.

In order to simplify calculation of the maximum of the SINRs, it is therefore judicious not to take this cell k into account. Thus, if μₖ<μ₁−λ (dB) where λ>0, the cell is not considered as potentially serving. λ is a parametrizable variable used to set a limit on the number of cells to be taken into consideration when calculating the maximum of the SINRs. For example, if λ=20 dB is set, then all cells with a mean power μ more than 20 dB away from the highest mean receive power are not taken into consideration when calculating the maximum SINR (i.e. SINR^{dB}), as the possibility of these cells acting as serving cells is negligible.

The number of cells to be taken into consideration when calculating the maximum SINR can therefore be reduced. M₀≤M, the number of cells with mean powers greater than or equal to μ₁−λ in dB, is therefore considered.

Thus, in a step E3, the maximum of the SINRs is determined as follows:

$${SINR}^{dB} = max ( {SINR}_{1}^{dB} , {SINR}_{2}^{dB} , ... , {SINR}_{{M}_{0}}^{dB} ) .$$

Typically, M₀=2, 3 or 4 cells.

However, all cells M are still considered in calculating the SINR, in equation EQ1. In other words, when calculating from SINR₁ to SINR_{M}_{₀} using equation EQ1, all M cells are taken into account.

The study of C. E. Clark, “The greatest of a finite set of random variables” in Operations Research, Vol. 9, No. 2, 145-162, 1961, enables us to calculate characteristic parameters for mean and variance for the maximum of two correlated normal random variables. Moreover, it is to be noted that the maximum between the two normal variables is approximated by a normal law. Thus, for the case of calculating the maximum of the SINRs where M₀ cells are potentially serving cells, calculating the maximum of the SINRs on the logarithmic scale amounts to maximizing two by two the quantities SINRᵢ^{dB}, 1≤i≤M₀.

For example, for M₀=4,

$${SINR}^{dB} = max ( max [ max ( {SINR}_{1}^{dB} , {SINR}_{2}^{dB} ) , {SINR}_{3}^{dB} ] , {SINR}_{4}^{dB} ) \qquad ( EQ 3 )$$

However, in the study of C. E. Clark, “The greatest of a finite set of random variables,” in Operations Research, Vol. 9, No. 2, 145-162, 1961, the correlation coefficients between the normal random variables are assumed to be known. On the contrary, in the case of cell network planning and optimization, the correlation coefficient between the SINRs of two neighboring cells on the logarithmic scale is not a known quantity.

Thus, in order to be able to calculate the characteristic parameters for the mean and variance of the maximum SINR (SINR^{dB}), in a step E4 the characteristic parameters for the distribution, i.e. the mean and variance, of SINRidB are determined using the Schwartz-Yeh technique described in the paper of C.-L. Ho, “Calculating the mean and variance of power sums with two log-normal components,” IEEE Trans. Veh. Technol., vol. 44, no. 4, pp. 756-762, 1995.

Indeed, as indicated in the paper “SINR and rate distributions for downlink cellular networks”, IEEE Transactions on Wireless Communications, vol. 19, no. 7, pp. 4604-4616, 2020, the SINR₁, (where 1≤i≤M), are normal random variables in the logarithmic domain, whose mean and variance can be calculated. The mean and variance of SINR₁^{dB} are then denoted by qᵢ, sᵢ², respectively.

In order to be able to apply the study of C. E. Clark, “The greatest of a finite set of random variables,” in Operations Research, Vol. 9, No. 2, 145-162, 1961, in a step E5, from qᵢ, sᵢ² the correlation coefficient between the SINRs of the set of M₀ cells are determined two by two.

It is reminded that the correlation coefficient between SINRᵢ^{dB} and SINRⱼ^{dB} for 1≤i≠j≤M₀ is:

$${τ}_{ij} = \frac{E [ {SINR}_{i}^{dB} {SINR}_{j}^{dB} ] - {q}_{i} {q}_{j}}{{s}_{i} {s}_{j}} \qquad ( EQ 2 )$$

However, in order to simplify determination of this correlation coefficient for network planning and optimization tools, an approximation of this correlation coefficient is given, unlike the study of C. E. Clark, “The greatest of a finite set of random variables,” in Operations Research, Vol. 9, No. 2, 145-162, 1961.

More particularly, the inventors suggest approximating τᵢⱼ by the mean of the possible values that τᵢⱼ can have given the possible values of the metrics:
1) of mean receive power of the signals transmitted by the M₀ cells taken into consideration,
2) of the value of shadowing,
3) of the correlation between cells and
4) of cell loads.

For this, in step E5, several Monte Carlo procedures are generated by varying the different metrics, described above, and at each iteration a new value of τᵢⱼ, 1≤i≠j≤M₀ is calculated and recorded in a random access memory M1 of a network performance monitoring system (respectively a network deployment planning system or a network operating parameter optimization system) set out below in connection with FIG. 5.

At the end of the iterations, a mean of a set of correlation coefficients calculated and recorded is calculated. At the end of this operation, the network performance monitoring system (respectively the network deployment planning system or the network operating parameter optimization system) only records the mean correlation coefficients for a pair of cells. The random access memory M1 of the network performance monitoring system (respectively the network deployment planning system or the network operating parameter optimization system) therefore only needs a small number of memory slots: 1 single mean coefficient for M₀=2, 3 mean coefficients for M₀=3, 6 for M₀=4, 10 for M₀=5, etc. The method provided above thus makes it possible to reserve limited memory space to record once and for all the mean values of the correlation coefficients between the SINRs measured for neighboring cells.

In one exemplary embodiment, a network is simulated with M=6 cells. As previously explained, cells with a low probability of being serving cells are neglected, so λ=20 dB is set. M₀=2, 3 or 4 potentially serving cells are thus obtained. 2000 Monte Carlo procedures are performed, corresponding to several possible values of the metrics:
of mean receive power for a signal transmitted by the first cell (CELL₁) such as −100≤μ₁≤−50 dBm,
of standard deviation of shadowing: 7≤σᵢ≤12 dB for 1≤i≤M,
of 4≤β≤10 dB; where β² is the variance of,
of the cell load 0.2≤ρ≤0.9,
of the mean receive powers of a signal transmitted by the other cells, given that:
   For M₀=2, μ1-μ₂≤20 dB and μ₁-μᵢ>20 dB for 3≤i≤6.
   For M₀=3, μ₁-μᵢ 20 dB for 2≤i≤3 and μ₁-μᵢ>20 dB for 4≤i≤6.
   For M₀=4, μ1-μᵢ 20 dB for 2≤i≤4 and μ₁-μᵢ>20 dB for 5≤i≤6.

2000 Monte Carlo procedures are generated for each value of M₀ ∈{2,3,4}. The correlation coefficient means for a pair of cells are given in Table 1 below.

TABLE 1

| | τ̅₁̅₂̅ | τ̅₁̅₃̅ | τ̅₁̅₄̅ | τ̅₂̅₃̅ | τ̅₂̅₄̅ | τ̅₃̅₄̅ |
|---|---|---|---|---|---|---|
| M₀ = 2 | −0.728 | — | — | — | — | — |
| M₀ = 3 | −0.681 | −0.349 | — | 0.033 | — | — |
| M₀ = 4 | −0.595 | −0.342 | −0.204 | −0.038 | 0.058 | 0.191 |

Table 1 above expresses the means of the correlation coefficients noted τ̅ᵢ̅ⱼ̅ for 1≤i≠j≤M₀, for different values of M₀. The same procedure can be used for higher values of M₀.

These different steps, referenced E1 to E5, make it possible to result in determining, in step E6, the mean and variance of the maximum of the SINRs on the logarithmic scale.

It is to be noted that step referenced E3 can be performed before, after or concomitantly with steps referenced E4 and E5.

In step E6, the mean and variance of the two-by-two maximum of SINRs are determined iteratively, based on the study of C. E. Clark, “The greatest of a finite set of random variables,” in Operations Research, Vol. 9, No. 2, 145-162, 1961, and the correlation coefficient determined in step E5.

For this, a variable Z₁=max(SINR₁^{dB}, SINR₂^{dB}) is considered.

Then, according to C. E. Clark, “The greatest of a finite set of random variables,” in Operations Research, Vol. 9, No. 2, 145-162, 1961:
the mean of Z₁ is written as:

$${q}_{Z 1} = f ( {q}_{1} , {q}_{2} , {s}_{1} , {s}_{2} , {τ}_{12} ) \qquad ( EQ 4.1 )$$

the moment of order 2 of Z₁ is written as:

$$E [ {Z}_{1}^{2} ] = g ( {q}_{1} , {q}_{2} , {s}_{1} , {s}_{2} , {τ}_{12} ) \qquad ( EQ 4.2 )$$

the variance of Z₁ is written as:

$${s}_{Z 1}^{2} = E [ {Z}_{1}^{2} ] - {q}_{Z 1}^{2} \qquad ( EQ 4.3 )$$

and the correlation coefficient between Z₁ and SINR₃^{dB} are respectively

$${τ}_{Z 1 , 3} = h ( {q}_{1} , {q}_{2} , {s}_{1} , {s}_{2} , {τ}_{12} , {τ}_{13} , {τ}_{23} ) \qquad ( EQ 4.4 )$$

$$Where f ( {q}_{1} , {q}_{2} , {s}_{1} , {s}_{2} , {τ}_{12} ) = {q}_{1} Φ ( \frac{{q}_{1} - {q}_{2}}{θ} ) + {q}_{2} Φ ( \frac{{q}_{2} - {q}_{1}}{θ} ) + θϕ ( \frac{{q}_{1} - {q}_{2}}{θ} )$$

$$g ( {q}_{1} , {q}_{2} , {s}_{1} , {s}_{2} , {τ}_{12} ) = ( {s}_{1}^{2} + {q}_{1}^{2} ) Φ ( \frac{{q}_{1} - {q}_{2}}{θ} ) + ( {s}_{2}^{2} + {q}_{2}^{2} ) Φ ( \frac{{q}_{2} - {q}_{1}}{θ} ) + ( {q}_{1} + {q}_{2} ) θϕ ( \frac{{q}_{1} - {q}_{2}}{θ} )$$

$$h ( {q}_{1} , {q}_{2} , {s}_{1} , {s}_{2} , {τ}_{12} , {τ}_{13} , {τ}_{23} ) = \frac{{s}_{1} {τ}_{13} Φ ( \frac{{q}_{1} - {q}_{2}}{θ} ) + {s}_{2} {τ}_{23} Φ ( \frac{{q}_{2} - {q}_{1}}{θ} )}{\sqrt{g ( {q}_{1} , {q}_{2} , {s}_{1} , {s}_{2} , {τ}_{12} ) - {( f ( {q}_{1} , {q}_{2} , {s}_{1} , {s}_{2} , {τ}_{12} ) )}^{2}}}$$

$$θ = \sqrt{{s}_{1}^{2} + {s}_{2}^{2} - 2 {τ}_{12} {s}_{1} {s}_{2}} ,$$

ϕ(.) is the probability density function of the standard (centered) normal law and
Φ(.) and the distribution function of the standard normal law.

If now one wants to calculate the same parameters for Z₂=max(Z₁,SINR₃^{dB}), it is sufficient to calculate q_{Z2}=f(q_{Z1},q₃,s_{Z1},s₃,τ_{Z1,3}) and E[Z₂²]=g(q_{Z1},q₃,s_{Z1},s₃,τ_{Z1,3}) then to deduce s_{Z2}².

If now one wants to calculate the same parameters for Z₃=max(Z₂,SINR₄^{dB}), it is sufficient to calculate q_{Z3}=f(q_{Z2},q₄,s_{Z2},s₄,τ_{Z2,4}) and E[Z₃²]=g(q_{Z2},q₄,s_{Z2},s₄,τ_{Z2,4}) then to deduce s_{Z3}² where τ_{Z2,4}=h(q_{Z1},q₃,s_{Z1},s₃,τ_{Z1,3},τ_{Z1,4},τ₃₄) and τ_{Z1,4}=h(q₁,q₂,s₁,s₂,τ₁₂,τ₁₄,τ₂₄).

And so on to SINR_{M}_{₀}^{dB}.

As previously mentioned, typical values for M₀ are 2, 3 or 4 cells. If:
M₀=2, then the maximum SINR^{dB}=Z₁. The mean and variance of SINR^{dB} are those of Z₁.
M₀=3, then the maximum SINR^{dB}=₂₂. The mean and variance of SINR^{dB} are those of Z₂.
M₀=4, then the maximum SINR^{dB}=Z₃. The mean and variance of SINR^{dB} are those of Z₃.

Advantageously, the error in estimating the correlation coefficient has little impact on the accuracy of estimating the characteristic parameters characteristic of the SINR on the logarithmic scale (mean and variance). It is therefore possible to use a mean correlation coefficient as an approximation of the correlation coefficient, as the error between the actual mean (respectively variance) and that calculated on the basis of approximated correlation coefficient values is small.

Indeed, let's take two correlated normal random variables of the respective variances γ₁² and γ₂². Let τ be the correlation coefficient between these two variables. According to equations EQ 4.1 and EQ 4.3, the mean and variance of the maximum of the two variables depend on the coefficient τ via the quantity α=\sqrt{γ₁²+γ₂²−2τγ₁γ₂}.

Now, let i be an approximated value of τ, then

$$α = \sqrt{( {γ}_{1}^{2} + {γ}_{2}^{2} - 2 \tilde{τ} {γ}_{1} {γ}_{2} ) ( 1 - \frac{2 e {γ}_{1} {γ}_{2}}{{γ}_{1}^{2} + {γ}_{2}^{2} - 2 \tilde{τ} {γ}_{1} {γ}_{2}} )} ,$$

$$where e = τ - \tilde{τ} . When Δ ≃ 1 ( where Δ = \sqrt{( 1 - \frac{2 e {γ}_{1} {γ}_{2}}{{γ}_{1}^{2} + {γ}_{2}^{2} - 2 \tilde{τ} {γ}_{1} {γ}_{2}} )} ) ,$$

α can be approximated by α≅\sqrt{γ₁²+γ₂²−2\tilde{τ}γ₁γ₂}. In this case, the approximated value of the correlation coefficient can be considered in the calculations.

In this case, the approximated value of τᵢⱼ is the mean τ̅ᵢ̅ⱼ̅ for 1≤i≠j≤M₀.

To evaluate accuracy of our averaging when calculating correlation coefficients, the metric of the relative error on quantity Δ, is considered, that is, quantity |Δ−1|.

To validate this theoretical approach set out in connection with FIG. 3, the inventors of the present patent application have simulated a network 1 with six cells, and considered several realizations corresponding to several values of the standard deviation of shadowing and several values of the difference between the mean receive powers of the two cells with the highest mean receive powers.

They also varied the difference between the mean receive powers with the other interfering cells. In particular, they simulate a network with M=6 cells and M₀=4 potentially serving cells. We consider 3000 Monte Carlo procedures corresponding to several values:
of the mean receive power of a signal transmitted by cell 1 such that −100≤μ₁≤−50 dBm,
of the mean receive powers of the signals transmitted by the cells, given that μ₁-μᵢ≤λ for 2≤i≤4 because M₀=4 and μ₁-μᵢ>λ for 5≤i≤6 with λ=20 dB,
of the standard deviation of shadowing: 7≤σᵢ≤12 dB for 1≤i≤M,
of 4≤β≤10 dB,
of 0.4≤ρ≤0.9.

Since M₀=4, there are 6 correlation coefficients to be calculated for each realizations. In the table below, the percentage where the relative error on the calculation of A is less than or equal to 15% is given.

TABLE 2

| | Approximation | Approximation | Approximation | Approximation | Approximation | Approximation |
|---|---|---|---|---|---|---|
| | of τ₁₂ | of τ₁₃ | of τ₁₄ | of τ₂₃ | of τ₂₄ | of τ₃₄ |
| \|Δ − 1\| < | 98% | 96% | 91% | 80% | 82% | 80% |
| 0.15 | | | | | | |

Table 2 represents the relative error on the value of Δ. The results in Table 2 justify approximation by the mean of the correlation coefficient, since the relative error is small (<0.15) in the majority of cases.

Now, SINR, measured for cell i is calculated. SINR, is the maximum between all the SINRs of the M₀ potential serving cells for the same experimental scenario.

We compare the mean of the SINR on the logarithmic scale (denoted by S̅I̅N̅R̅_̅{̅d̅B̅}̅) with our theoretical approximation.

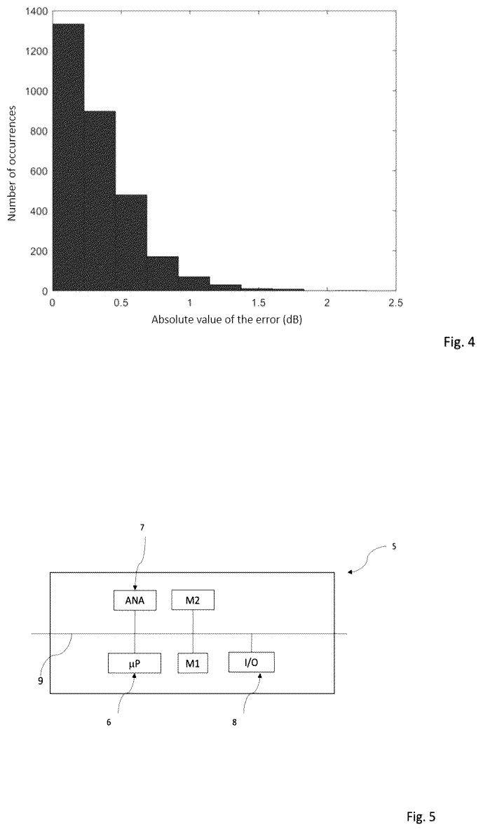

In FIG. 4, the histogram of the absolute value of the error between S̅I̅N̅R̅_̅{̅d̅B̅}̅ and the approximated value is given. It is noticed that the theoretical method according to the development is able to properly estimate the maximum of the SINR, as the error on the mean does not exceed 1.5 dB in the majority of cases.

The low error of the SINR variance estimation with the method according to the development is also noticeable.

In connection with FIG. 5, the hardware structure of a system for monitoring performance of a cellular radiocommunication network according to one embodiment of the development, or of a system for planning deployment of a cellular radiocommunication network, or of a system for optimizing operating parameters of a cellular radiocommunication network, is now set forth.

Such a system referenced 5 comprises a unit for estimating characteristic parameters of a reception quality at a location of the cellular radiocommunication network, and a unit for analyzing network performance (respectively a unit for determining network planning parameters or a unit for determining optimized network operating parameters), as a function of the characteristic parameters estimated.

The term unit can refer to a software component as well as a hardware component or a set of hardware and software components, a software component itself corresponding to one or more computer programs or sub-programs, or more generally to any element in a program able to implement a function or set of functions.

More generally, such a network performance monitoring system 5 (respectively network deployment planning system or network operating parameter optimization system) comprises a random access memory M1 (e.g. RAM memory), a processing unit 6 equipped with, for example, a processor, and driven by a computer program, representative of the unit for estimating characteristic parameters of a reception quality at a location of the cellular radiocommunication network, stored in a read-only memory M2 (e.g. ROM memory or hard disk). Upon initialization, computer program code instructions, for example, are loaded into the RAM M1 before being executed by the processor of the processing unit 6. The RAM M1 especially contains the different variables used in the calculations described above in connection with FIG. 3. The processor of processing unit 6 drives calculation of the means and variances of the signal-to-interference-plus-noise ratios of the plurality of potential serving cells, calculation of the correlation coefficient, as well as calculation of the mean and variance of the SINR on the logarithmic scale, corresponding to the maximum of the SINR^{dB} ratios.

The random access memory M1 can also contain the results of calculations performed by the processor of the processing unit 6. It can provide these results to a network performance analysis unit 7 (respectively a network planning parameter determination unit or an optimized network operating parameter determination unit), equipped with a processor and driven by a computer program. This processor may be the same as, or separate from, that of the processing unit 6.

The system 5 also comprises an I/O module 8 for outputting to the network operator the results of the network performance analysis performed by the analysis unit 7 (respectively the results of the planning parameter determination performed by the network planning parameter determination unit 7 or the results of the optimized operating parameter determination performed by the network optimized operating parameter determination unit 7).

All components M1, M2, 6, 7 and 8 of the system 5 are linked, for example, via a communication bus 9.

FIG. 5 illustrates only one particular way, of several possible ways, of making the network performance monitoring system (respectively the network deployment planning system or the network operating parameter optimization system), to perform the steps of the method detailed above, in connection with FIGS. 1 to 3 (in any of the one embodiments, or in a combination of these embodiments). Indeed, these steps may be implemented indifferently on a reprogrammable computing machine (a PC computer, a DSP processor or a microcontroller) executing a program comprising a sequence of instructions, or on a dedicated computing machine (for example a set of logic gates like an FPGA or an ASIC, or any other hardware module).

In the case where the network performance monitoring system 5 (respectively the network deployment planning system or the network operating parameter optimization system) is implemented with a reprogrammable calculation machine, the corresponding program (i.e. the instruction sequence) can be stored in a removable storage medium (such as, for example, a floppy disk, CD-ROM or DVD-ROM) or not, this storage medium being partially or totally readable by a computer or processor.

1. A method for estimating characteristic parameters of a reception quality at a location in a cellular radiocommunication network,
wherein the method comprises:
selecting, from a set of cells of said network, at least two cells associated with the highest mean receive powers of a useful signal at said location (CELL₁, CELL₂ . . . CELL_{M});
determining, on the logarithmic scale, at least two signal-to-interference plus noise ratios at said location for said useful signal received from each of said at least two selected cells (SINR^{dB}₁, SINR^{dB}₂ . . . SINR^{dB}_{M});
determining a correlation coefficient between said at least two signal-to-interference-plus-noise ratios determined on the logarithmic scale;
determining a maximum between said at least two signal-to-interference-plus-noise ratios determined on the logarithmic scale; and
estimating said characteristic parameters of a reception quality at said location from said maximum and said correlation coefficient.

2. The method for estimating characteristic parameters of a reception quality according to claim 1, wherein said determining said correlation coefficient comprises an approximation of said correlation coefficient, said approximation being determined from calculating a mean of a set of correlation coefficients between said at least two signal-to-interference-plus-noise ratios determined on the logarithmic scale,
and in that said estimating said characteristic parameters of a reception quality at said location is done from said maximum and from said correlation coefficient approximated from said mean calculated.

3. The method for estimating characteristic parameters of a reception quality according to claim 1, wherein the method further comprises:
calculating a mean (q(SINR₁, SINR₂ . . . SINR_{M})) and a variance (s²(SINR₁, SINR₂ . . . SINR_{M})) associated with each of said at least two signal-to-interference-plus-noise ratios determined on the logarithmic scale, said determining said correlation coefficient between said at least two signal-to-interference-plus-noise ratios determined on the logarithmic scale being performed from said means and variances calculated associated with each of said at least two signal-to-interference-plus-noise ratios determined on the logarithmic scale.

4. The method for estimating characteristic parameters of a reception quality according to claim 3, wherein said correlation coefficient is determined according to the formula:
$${τ}_{ij} = \frac{E [ {SINR}_{i}^{dB} {SINR}_{j}^{dB} ] - {q}_{i} {q}_{j}}{{s}_{i} {s}_{j}}$$
where:
SINRᵢ and SINRⱼ respectively designate said at least two signal-to-interference-plus-noise ratios determined on the logarithmic scale of said at least two cells,
qᵢ and qⱼ respectively designate said means associated with each of said at least two signal-to-interference-plus-noise ratios determined on the logarithmic scale,
sᵢ and sⱼ respectively designate said variances associated with each of said at least two signal-to-interference-plus-noise ratios determined on the logarithmic scale.

5. The method for estimating characteristic parameters of a reception quality according to claim 3, wherein said estimating said characteristic parameters comprises calculating at least some of the elements belonging to a group comprising:
a mean of said maximum calculated; and
a variance of said maximum calculated;
from said correlation coefficient determined, and then approximated by the mean of said correlation coefficient determined and said means and variances associated with each of said at least two signal-to-interference-plus-noise ratios determined on the logarithmic scale.

6. The method for estimating characteristic parameters of a reception quality according to claim 5, wherein said mean of said maximum calculated is calculated according to the formula:
$${q}_{z} = {q}_{i} Φ ( \frac{{q}_{i} - {q}_{j}}{θ} ) + {q}_{j} Φ ( \frac{{q}_{j} - {q}_{i}}{θ} ) + θϕ ( \frac{{q}_{i} - {q}_{j}}{θ} )$$
$$\text{where:} θ = \sqrt{{s}_{i}^{2} + {s}_{j}^{2} - 2 {τ}_{ij} {s}_{i} {s}_{j}} ,$$
ϕ(.) is the probability density function of the standard centered normal law,
Φ(.) is the distribution function of the standard normal law,
qᵢ and qⱼ respectively designate said means associated with each of said at least two signal-to-interference-plus-noise ratios determined on the logarithmic scale,
sᵢ² and sⱼ² respectively designate said variances associated with each of said two signal-to-interference-plus-noise ratios determined on the logarithmic scale, and
τᵢⱼ is said correlation coefficient between said two signal-to-interference-plus-noise ratios determined on the logarithmic scale.

7. The method for estimating characteristic parameters of a reception quality according to claim 6, wherein said variance of said maximum calculated is calculated according to the formula:
$${s}_{z}^{2} = ( {s}_{i}^{2} + {q}_{i}^{2} ) Φ ( \frac{{q}_{i} - {q}_{j}}{θ} ) + ( {s}_{j}^{2} + {q}_{j}^{2} ) Φ ( \frac{{q}_{j} - {q}_{i}}{θ} ) + ( {q}_{i} + {q}_{j} ) θϕ ( \frac{{q}_{i} - {q}_{j}}{θ} ) - {( {q}_{z} )}^{2}$$
$$\text{where:} θ = \sqrt{{s}_{i}^{2} + {s}_{j}^{2} - 2 {τ}_{ij} {s}_{i} {s}_{j}} ,$$
ϕ(.) is the probability density function of the standard centered normal law,
Φ(.) is the distribution function of the standard normal law,
qᵢ and qⱼ respectively designate said means associated with each of said two signal-to-interference-plus-noise ratios determined on the logarithmic scale,
sᵢ² and sⱼ² respectively designate said variances associated with each of said two signal-to-interference-plus-noise ratios determined on the logarithmic scale,
τᵢⱼ is said correlation coefficient between said two signal-to-interference-plus-noise ratios determined on the logarithmic scale, and
q_{Z} is said mean of said maximum calculated.

8. The method for estimating characteristic parameters of a reception quality according to claim 1, wherein determining said maximum comprises a calculation between said at least two logarithmically determined signal-to-interference-plus-noise ratios, said calculation comprising, if necessary, determining, among said at least two selected cells, at least two cells having between them a mean power difference greater than or equal to a predetermined threshold (λ).

9. A processing circuit comprising a processor and a memory, the memory storing program code instructions of a computer program to execute the method according to claim 1, when the computer program is executed by the processor.

10. A method for planning the deployment of a cellular radiocommunication network, wherein the method implements estimating characteristic parameters of a reception quality at a location of said network according to claim 1, and determining parameters for planning said network as a function of said characteristic parameters estimated.

11. A method for optimizing operating parameters of a cellular radiocommunication network, wherein the method implements estimating characteristic parameters of a reception quality at a location of said network according to claim 1, and determining optimized operating parameters of said network as a function of said characteristic parameters estimated.

12. A method for monitoring performance of a cellular radiocommunication network, wherein the method implements estimating characteristic parameters of a reception quality at a location of said network according to claim 1, and estimating at least one performance criterion of said network as a function of said characteristic parameters estimated.

13. A system for planning deployment of a cellular radiocommunication network, wherein the system comprises a processor configured to execute the steps of the method for estimating characteristic parameters of a reception quality at a location of said network according to claim 1, and to determine planning parameters of said network as a function of said characteristic parameters estimated.

14. A system for optimizing operating parameters of a cellular radiocommunication network, wherein the system comprises a processor configured to execute the steps of the method for estimating characteristic parameters of a reception quality at a location of said network according to claim 1, and to determine optimized operating parameters of said network as a function of said characteristic parameters estimated.

15. A system for monitoring performance of a cellular radiocommunication network, wherein the system comprises a processor configured to perform the steps of the method for estimating characteristic parameters of a reception quality at a location of said cellular radiocommunication network according to claim 1, and to analyze performance of said network as a function of said characteristic parameters estimated.
